(19) United States
(12) Patent Application Publication
(10) Pub. No.: US 2014/0280957 A1
(43) Pub. Date: Sep. 18, 2014

(54) Dynamic Assembly and Dispatch of Controlling Software

(71) Applicant: Silicon Graphics International Corp., Milpitas, CA (US)

(72) Inventors: Charles Robert Martin, Superior, CO (US); Lance MacKimmie Evans, Boulder, CO (US)

(73) Assignee: Silicon Graphics International Corp., Milpitas, CA (US)

(21) Appl. No.: 13/831,671

(22) Filed: Mar. 15, 2013

(51) Int. Cl. H04L 12/911

(52) U.S. Cl. CPC H04L 47/70
USPC 709/226

(57) ABSTRACT

Embodiments of the invention include software that provides an operator or a system service the ability to access, control, or configure a plurality of different data center resources using common sets of functions or commands even though those data center resources natively require different commands to access, control, or configure them. The invention is configured to accept common commands and then translate them from a common command format into device specific commands or command sets. The invention simplifies how data center equipment is controlled and configured.

### BACKGROUND OF THE INVENTION

1. Field of the Invention

The present invention generally relates to software that provides an operator or software modules the ability to access, control, or configure different data center resources using common sets of commands.

2. Description of the Related Art

The modern data center contains a plurality of heterogeneous types of resources that include, yet are not limited to, compute resource (nodes), servers, solid state disks, disk drives, tape drives, data storage arrays, automated tape libraries, network adaptors, and other forms of electronic equipment. Today, data center resources are controlled by a plurality of disparate forms of controlling software. In this environment, various different pieces of equipment require different control software each with a unique user interface and command sets.

Similar types of equipment often require different pieces of software to control or configure them. For example, if one had to control different data storage arrays such as a disk array without an integrated controller—colloquially, “just a bunch of disks” (JBOD) made by different data storage vendors, each individual JBOD array would require different control software because control functions designed for one vendor of JBOD array is different from another vendor. Even JBOD arrays made by the same vendor of different product generations may require different control software when controlling or configuring them.

This problem is exacerbated by the fact that the data center contains a plurality of different types of devices. There can thus be dozens or hundreds of pieces of equipment in the data center that require different control software to control and configure them.

Because of this, data center administrators are overwhelmed with mastering a plurality of different user interfaces that must be used to control each different piece of hardware in the data center. As such, there is a great need in the data center today to simplify how equipment is controlled and configured.

### SUMMARY OF THE INVENTION

Embodiments of the invention simplify the job of data center operators by enabling operators or software modules external to the invention the ability to access, control, or configure a plurality of different data center resources using common sets of functions or commands. The invention is configured to accept common functions or commands and then translate them from a common command format into device specific commands or command sets.

In certain embodiments an operator can access, control, or configure a plurality of different data center hardware resources through a common user interface with common control functions. Furthermore, other software programs running in the data center can use the same set of control functions to access, control, or configure the same data center hardware resources as those controlled by the user interface. To accomplish this, software consistent with the invention encapsulates the control functions required to control various different pieces of data center equipment, and abstracts them from the operator or from the system service wishing to control, configure, or access those pieces of equipment.

Certain embodiments of the invention utilize at least three software modules that include: at least one action module, a user interface module, and a dispatch module. Action modules describe services or functions and map those services or functions to commands or command sets used to access, control, or configure specific types of data center hardware resources.

Command and control functionality of the user interface module and of the dispatch module are typically dynamically updated as soon as an action module is loaded. This can also occur even when action modules are loaded during runtime.

The user interface module allows an operator to access, control, or configure data center hardware resources typically using a command line interface. The invention's user interface is not limited to the use of a command line interface, as other forms of user interfaces may be incorporated into the invention, such as an interface provided through a network browser application.

The dispatch module allows other programs running in the data center to access, control, or configure data center resources through the same common command sets that are used by the user interface module. Thus, the invention enables data center resources to be controlled by a user interface or by other software programs typically without updating or changing the configuration of those other software programs when new hardware is added. Furthermore, the user interface module and the dispatch module typically do not require updates when new hardware is added to the data center. Instead, new functionality is added to the data center by adding or updating an action module.

The invention thus simplifies how data center equipment is accessed, controlled, and configured by translating common input commands into device specific commands or sets of commands.

### BRIEF DESCRIPTION OF THE DRAWINGS

FIG. 1 illustrates various storage elements located inside and outside the data center.

FIG. 2 illustrates a simplified flow diagram of the invention accepting common commands and communicating with different data storage devices.

FIG. 3 illustrates an embodiment of the invention including a solid state disk that is not currently configured to receive commands.

FIG. 4 illustrates an embodiment of the invention adding new functionality to the data center.

### DETAILED DESCRIPTION

Embodiments of the invention simplify the job of data center operators by enabling operators or software modules external to the invention the ability to access, control, or configure a plurality of different data center resources using common sets of functions or commands. The invention is configured to accept common functions or commands and then translate them from a common command format into device specific commands or command sets.

In certain embodiments, an operator can access, control, or configure a plurality of different data center hardware resources through a common user interface with common control functions. Furthermore, other software programs running in the data center can use the same set of control functions to access, control, or configure the same data center hardware resources as those controlled by the user interface.

Certain embodiments of the invention utilize at least three software modules that include: at least one action module, a user interface module, and a dispatch module. These modules are components of the system that might be widely distributed. In general, the dispatcher loads action modules from some persistent store, and communicates with the user interface module either directly, called as a subroutine, or through a network or messaging connection. Action modules describe services or functions and map those services or functions to commands or command sets used to access, control, or configure specific types of data center hardware resources. Action modules also encapsulate control functions required to control various different pieces of data center equipment and abstracts them from the operator or from other software programs wishing to control, configure, or access particular data center equipment. Action modules may also include text reviewing syntactic requirements of the command line interface or action modules may provide other useful instructions to an operator using the user interface.

FIG. 1 illustrates various storage elements located inside and outside of the data center. The data center may be configured to communicate with various computers located external to the physical boundaries of the data center. FIG. 1 depicts a Data Center 101 with a plurality of internal elements including a plurality of Compute Resources 102, a plurality of solid state drives (SSDs) 103, a plurality of slower disk drives 104, a plurality of tape drives 105, Network Adaptors 106, and a wireless network antenna 107. Wired network cables 108 connect the Data Center's 101 Network Adaptors 106 to a plurality of Desktop Computers 109 that are outside of the Data Center 101, Notebook Computers with wireless network antennas 110 are also depicted outside of the Data Center 101, and may communicate with the data center via one or more wireless protocols.

Command and control functionality of the user interface module and of the dispatch module are typically dynamically updated as soon as an action module is loaded. This can also occur even when action modules are loaded during runtime.

The user interface module allows operators access, control, or configure data center hardware resources typically using a command line interface. The invention's user interface is not however limited to the use of a command line interface, as other forms of user interfaces may be incorporated into the invention including yet not limited a web page user interface.

For example, if an operator wishes to configure two different data storage arrays to implement RAID 1 (mirroring) on a first set of two disks contained within each of the two arrays, an operator could command software consistent with the invention to configure RAID1 on each data storage array using a single command set. The software would abstract the different types of commands sent to each data storage array from the operator. In this instance, software consistent with the invention is aware of that the different data storage arrays require different commands to configure RAID 1 and knows what those specific commands are to perform that task on each of the different data storage arrays: The invention thus translates the particular function “configure RAID 1 on the first two disks” commanded by the operator into different commands or sets of commands as required to perform the function. Software consistent with the invention can be configured in various embodiments to control many different types of equipment, thus the invention is scalable and is not limited to controlling one class of equipment.

The dispatch module allows other programs running in the data center to access, control, or configure data center resources through the same common command sets that are used by the user interface module. Thus, the invention enables data center resources to be controlled by a user interface or by other software programs typically without updating or changing the configuration of those other software programs when new hardware is added. Furthermore, the user interface module and the dispatch module typically do not require updates when new hardware is added to the data center. Instead, new functionality is added to the data center by adding or updating an action module.

FIG. 2 illustrates a simplified flow diagram of the invention accepting common commands and communication with different data storage devices. Requests or commands may be received by the invention from operator input 210 or from other software programs 220 communicating with an embodiment of the invention. Requests or commands initiated by an operator are input through a user interface module 230, and requests or commands from other software programs 220, communicating with the invention, pass through the dispatch module 240. Requests or commands passed though the user interface module 230 or through the dispatch module 240 are passed to the action module 250 into a common command interface 251 using a common protocol. After requests or commands are received by the common command services interface 251 the requests or commands are translated from their common command format into device specific commands or command sets 252, after which they are sent to an interface 253 that prepares the commands to be sent to individual hardware devices. Finally, commands are sent to individual data storage resources: 260 data storage device 1, 261 data storage device 2, and 270 automated tape library. Even though 260 data storage device 1 and 261 data storage device 2 may receive similar classes of commands, the devices themselves may require different command formats or structures for those devices to understand and interpret those commands.

FIG. 3 illustrates an embodiment of the invention including a solid state disk that is not currently configured to receive commands. FIG. 3 show a user interface module 330 and a dispatch module that are configured to communicate with an action module 350. The action module 350 is configured to communicate with a data storage array 360 and an automated tape library 370. Solid state disk 380 is not configured to communicate with action module 350. Because of this, the user interface module 330 or dispatch module 340 also cannot communicate with the solid state disk 380.

FIG. 4 illustrates an embodiment of the invention adding new functionality to the data center. Here again, the user interface module 330 and a dispatch module 340 are configured to communicate with an action module 350. Action module 350 is configured to communicate with a data storage array 360 and an automated tape library 370. The solid state disk 380, however, is now configured to communicate with a new action module 450. New action module 450 configures interface module 330 and dispatch module 340 to communicate with solid state disk 380 using commands described in the action module.

Certain embodiments of the invention are configured to load action modules into the user interface module and into the dispatch model. This is conceptually similar to plugging in a FLASH memory chip into a camera where once installed in the camera, the FLASH memory chip is considered part of the camera. Other embodiments of the invention may be implemented where action modules communicate with user interface modules and with dispatch modules. This is conceptually similar to connecting a USB dongle containing a FLASH memory chip to a computer—here however the FLASH memory chip may be viewed as being attached to the computer instead of being part of the computer. Similarly, the invention may be implemented in various ways yet still within the scope of the invention.

Examples of software programs that may communicate with dispatch modules of the invention include yet are not limited to: SGI® Data Migration Facility (DMF), SGI® XFS or CXFS files systems, parallel distributed databases such as LiveArcrm, or other similar system services.

Examples of hardware accessed, controlled, or configured by the invention include yet are not limited to: disk drives, tape drives, automated tape libraries, data storage device arrays, network file system appliances, or parallel multi-core supercomputers.

The invention thus simplifies how data center equipment is accessed, controlled, and configured by translating common input functions or commands into device specific commands or sets of commands.

The above description is illustrative and not restrictive. Many variations of the invention will become apparent to those of skill in the art upon review of this disclosure. While the present invention has been described in connection with a variety of embodiments, these descriptions are not intended to limit the scope of the invention to the particular forms set forth herein. To the contrary, the present descriptions are intended to cover alternatives, modifications, and equivalents as may be included within the spirit and scope of the invention as defined by the appended claims and otherwise appreciated by one of ordinary skill in the art

What is claimed is:

1. A method for managing data center resources, comprising:
receiving a command from an operator interface targeting data center resources specified by an operator;
transmitting common commands targeting the data center resources;
accepting commands from and transmitting common commands targeting data center resources;
accepting common commands from targeting data center devices specified by the operator; and
translating the common commands into device specific commands or sets of commands.

2. The method of claim 1, further comprising sending commands to a data center resource targeted by the operator.

3. The method of claim 2 further comprising loading a second action model configured to accept common commands from a user interface module, the second action model specified by the operator or by the other software programs communicating with the dispatch module.

4. The method of claim 3 further comprising the second action module loading during runtime and configured to send the device specific commands or sets of commands to a new data center resource targeted by the operator or by the other software communicating with the dispatch module without interrupting the operation of the data center.

5. The method of claim 3 further comprising loading a third action model configured to accept common commands from the user interface module or from the dispatch module targeting the data center devices specified by the operator or by the other software programs communicating with the dispatch module, and translate the common commands into device specific commands or sets of commands.

6. A system managing data center resources, controlling, comprising:
a processor;
memory; and
one or more modules stored in memory and executable by the processor to:
receive an initial command from an operator interface targeting data center resources specified by an operator;
transmit common commands targeting the data center resources;
accept commands from and transmit common commands targeting data center resources;
accept common commands from targeting data center devices specified by the operator; and
translate the common commands into device specific commands or sets of commands.

7. The system of claim 6, wherein the modules are further executable to send commands to a data center resource targeted by the operator.

8. The system of claim 7, wherein the modules are further executable to load a second action model configured to accept common commands from a user interface module, the second action model specified by the operator or by the other software programs communicating with the dispatch module.

9. The system of claim 8, wherein the modules are further executable to load during runtime and configured to send a device specific command or sets of commands to new data center resources targeted by the operator or by the other software communicating with the dispatch module without interrupting the operation of the data center.

10. The system of claim 8, wherein the modules are further executable to load a third action model configured to accept common commands from the user interface module or from the dispatch module targeting the data center devices specified by the operator or by the other software programs communicating with the dispatch module, and translate the common commands into device specific commands or sets of commands.

11. A computer readable non-transitory storage medium having embodied thereon a program, the program being executable by a processor to perform a method for managing data center resources, the method comprising:
receiving a command from an operator interface targeting data center resources specified by an operator;
transmitting common commands targeting the data center resources;
accepting commands from and transmitting common commands targeting data center resources;
accepting common commands from targeting data center devices specified by the operator; and
translating the common commands into device specific commands or sets of commands.

12. The computer readable non-transitory storage medium of claim 11, further comprising sending commands to a data center resource targeted by the operator.

13. The computer readable non-transitory storage medium of claim 12, further comprising loading a second action model configured to accept common commands from a user interface module, the second action model specified by the operator or by the other software programs communicating with the dispatch module.

14. The computer readable non-transitory storage medium of claim 13, further comprising the second action module loading during runtime and configured to send the device specific commands or sets of commands to new data center resources targeted by the operator or by the other software communicating with the dispatch module without interrupting the operation of the data center.

15. The computer readable non-transitory storage medium of claim 13, further comprising loading a third action model configured to accept common commands from the user interface module or from the dispatch module targeting the data center devices specified by the operator or by the other software programs communicating with the dispatch module, and translate the common commands into device specific commands or sets of commands.
